(19) United States
(12) Patent Application Publication
(10) Pub. No.: US 2013/0187962 A1
(43) Pub. Date: Jul. 25, 2013

(54) Mixed Transmissive-Reflective-Transflective Liquid Crystal Display

(71) Applicant: Pixel Qi Corporation, San Bruno, CA (US)

(72) Inventors: Carlin Vieri, Menlo Park, CA (US); Mary Lou Jepsen, Sausalito, CA (US); Ruibo Lu, San Bruno, CA (US); John Ryan, Sausalito, CA (US)

(73) Assignee: PIXEL QI CORPORATION, San Bruno, CA (US)

(21) Appl. No.: 13/745,543

(22) Filed: Jan. 18, 2013

Related U.S. Application Data
(60) Provisional application No. 61/589,533, filed on Jan. 23, 2012.
(60) Provisional application No. 61/643,068, filed on May 4, 2012.

(51) Int. Cl. G09G 3/20

(52) U.S. Cl. CPC G09G 3/20
USPC 345/698

(57) ABSTRACT

A display panel comprises two or more display portions having two or more different types of pixels in two or more different spatial segments of the display panel. The display panel may be coupled to a display driving circuit configured to drive two or more display portions in two or more different spatial segments of the display panel to operate in two or more different display modes.

### BENEFIT CLAIM

This application claims the benefit, under 35 U.S.C. 119(e), of prior provisional application 61/589,533, filed Jan. 23, 2012, and prior provisional application 61/643,068, filed May 4, 2012, the entire contents of which are hereby incorporated by reference for all purposes as if fully set forth herein.

### FIELD OF THE DISCLOSURE

The present disclosure generally relates to liquid crystal displays.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A single display screen of a computing device may be used to display different display items relating to different applications running on the device. Some display items such as icons may be relatively static and/or low resolution. Some display items such as electronic books may use relatively limited shades of gray. Some display items such as video/image applications may need to be displayed in full color with a high resolution at a high frame refresh rate.

### BRIEF DESCRIPTION OF THE DRAWINGS

Various embodiments of the present invention will herein after be described in conjunction with the appended drawings, provided to illustrate and not to limit the present invention, wherein like designations denote like elements, and in which:

FIG. 1 is a schematic of a cross section of a pixel of a LCD;

FIG. 2A and FIG. 2B illustrate example display panels operatively coupled to example display driving circuits;

FIG. 3 illustrates an example variable or mixed refresh rate update of a display panel;

FIG. 4, FIG. 5A and FIG. 5B illustrate example display states of a display panel;

FIG. 6 illustrates an example computing device, according an embodiment.

The drawings are not rendered to scale.

### DETAILED DESCRIPTION

Techniques for supporting concurrent display modes in a display panel are described. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

Example embodiments are described herein according to the following outline (outline section headings are for reference purposes only and shall not in any way control the scope of the present invention):

1. GENERAL OVERVIEW

2. EXAMPLE EMBODIMENTS

3. EXAMPLE COMPUTING DEVICE

4. EQUIVALENTS, EXTENSIONS, ALTERNATIVES AND MISCELLANEOUS

### 1. GENERAL OVERVIEW

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Techniques as described herein may be used to enable a display panel to concurrently support multiple display modes for rendering images to a user/viewer. Two or more display modes may be configured to concurrently operate in two or more different display portions of the display panel. For example, a computing device may host one or more computing applications that generate a plurality of display items. Under the techniques as described herein, individual display items from these computing applications may be concurrently rendered in a plurality of display portions of a display panel. Further, the computing device may be configured to operate with different display and/or power characteristics in different display portions of the display panel in concurrently rendering the plurality of display items.

Concurrently supported display modes as described herein may be operated in conjunction with a variety of spatial configurations of a display panel, screen viewing experiences and power consumption configurations. For example, a display panel as described herein may comprise a combination of one or more of transmissive display sections, reflective display sections, transflective display sections, OLED display sections, MEMS display sections, etc. In some embodiments, a display section itself may be sub-divided into different display portions operating concurrently in different display modes. Examples of display modes include, without limitation, lower power modes with continuous display of slowly changing images, sunlight readability modes, high color saturation and high contrast modes, or display modes of extremely low power display of “notification” type data, etc.

In an example, a mobile phone may comprise a display panel, which may have a high resolution, full color display portion for certain functions and which may also have a secondary display portion that is lower resolution and black and white, and therefore lower cost and lower power, for providing a continuous display of the time or as an alert for incoming calls. In another example, an electronic reading device may comprise a display panel, which may have a large reflective display for presenting reading materials and which may also have a second, transmissive (e.g., LCD) or emissive (e.g., OLED) display for the control functions of the electronic reader, such as browsing the stored library of books, changing the settings of the reader, or providing limited web browsing.

Thus, a single display panel may be configured to concurrently support very different display-related operations, functions, features and characteristics in a single display module.

Embodiments include a computing device configured to update pixels in a display panel in a manner other than row-sequential, in order to reduce power consumption of the display and/or to properly address different display portions (segments, sections, etc.) in the display panel.

Embodiments include a pixel array design, drive electronics and driving schemes configured to update the different display portions of a display panel. Embodiments include system-level control features that determine how and if different display portions of the display panel are driven. A wide variety of different pixel or subpixel designs may be used to implement techniques as described herein. Additionally, optionally, or alternatively, a wide variety of backlight module designs that support a range of illumination options may be used to implement techniques as described herein. A wide variety of display technologies including but not limited to LCD, OLED, MEMS, etc. may be used to implement techniques as described herein.

Embodiments include a display panel that comprises two or more display portions having two or more different types of pixels in two or more different spatial segments of the display panel.

Embodiments include a display panel that is coupled to a display driving circuit configured to drive two or more display portions in two or more different spatial segments of the display panel to operate in two or more different display modes.

In an embodiment, the display panel represents a single monolithic display module.

In an embodiment, the display panel is coupled with one or more of address decoders, shift registers, row or column drivers.

In an embodiment, at least one of the two or more different display portions in the display panel compresses one or more of transmissive pixels, reflective pixels, transflective pixels, OLED pixels, or MEMS pixels. In an embodiment, at least one of the two or more different display portions in the display panel is illuminated by one or more of back lights, front lights, or ambient light.

In an embodiment, image content on at least two of the two or more different display portions in the display panel is configured to be refreshed at two different refreshing rates.

In an embodiment, at least two display portions among the two or more different spatial segments in the display panel are configured to concurrently operate in a full power display mode and in a low power display mode, respectively. In an embodiment, at least two display portions among the two or more different spatial segments in the display panel are configured to concurrently operate in a transmissive or transflective display mode and in a reflective only display mode, respectively.

In an embodiment, the two or more display portions are dynamically allocated based on a particular mix of running applications that collectively generate images to be rendered on the display panel. In an embodiment, at least one of the two or more display portions comprises consecutive rows.

In an embodiment, at least one of the two or more display portions is coupled to electric circuitry configured to prevent dc electric fields.

In an embodiment, the display panel is configured to operate in a system or user configurable state among a plurality of display states supported by the display panel.

Embodiments include a computing device that comprises one or more computing processors and a display panel as previously described, which is coupled to the one or more computing processors. Embodiments include a method for fabricating a display panel as previously described. Embodiments include a method for rendering images using a display panel as previously described.

In some embodiments, a display panel as described herein forms a part of a computer, including but not limited to a laptop computer, netbook computer, cellular radiotelephone, electronic book reader, point of sale terminal, desktop computer, computer workstation, computer kiosk, or computer coupled to or integrated into a gasoline pump, and various other kinds of terminals and display units.

### 2. EXAMPLE EMBODIMENTS

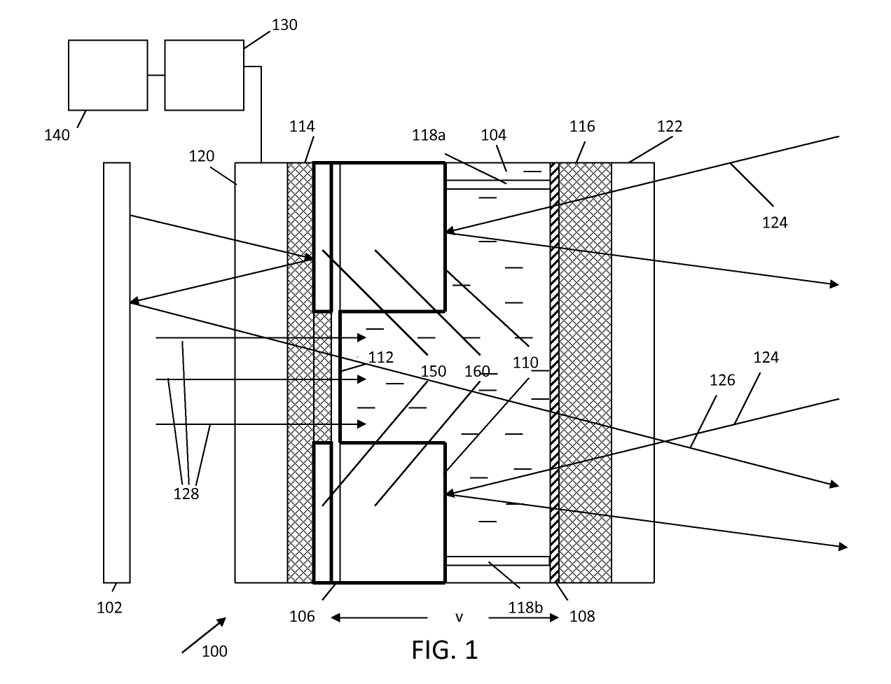

FIG. 1 is a schematic of a cross section of a pixel 100 of a LCD. In some embodiments, multiple display portions on a display panel such as the LCD here may be configured to concurrently operate in different display modes, e.g., transmissive mode, reflective mode, transflective mode, low power mode, normal power mode, low refresh rate mode, high refresh mode, low resolution mode, high resolution mode, full color mode, limited grayscale mode, etc. Pixel 100 comprises a liquid crystal material 104, a pixel electrode or a first electrode layer 106 that includes switching elements, a common electrode or a second electrode layer 108, a first reflective layer 160 that is located on one side of electrode 106, a second reflective layer 150 that is located on the other side of the electrode 106, a transmissive part 112, first and second substrate layers 114 and 116, spacers 118a and 118b , a first polarization layer 120, and a second polarization layer 122.

In an embodiment, first and second reflective layers 160 and 150 have an opening over the transmissive part 112. A surface of first reflective layer 160 forms in part a reflective part 110. A surface of second reflective layer 150 may be used to reflect light incident from the left-hand side of the surface. In an embodiment, a light source 102 or a front light 124 illuminates pixel 100. Examples of light source 102 include, but are not limited to, Light Emitting Diodes backlights (LEDs), Cold-Cathode Fluorescent Lamps backlights (CCFLs), and the like. Front light 124 can be ambient light such as sunlight, light from a front light unit, or an external source of light. In an embodiment, liquid crystal material 104, which is an optically active material, rotates the axis of the polarization of the light from light source 102 or front light 124. Liquid crystal 104 can be a Twisted Nematic (TN), an Electrically Controlled Birefringence (ECB) and the like. In an embodiment, the rotation of the polarization orientation of the light is determined by the potential difference applied between pixel electrode 106, and common electrode 108. In an embodiment, pixel electrode 106 and common electrode 108 can be made of Indium Tin Oxide (ITO). Further, each pixel is provided with a pixel electrode 106, while common electrode 108 is common to all the pixels present in the LCD.

In an embodiment, reflective part 110 is electrically conductive and reflects front light 124 to illuminate pixel 100. The first reflective layer 160 is made of metal and is electrically coupled to pixel electrode 106 thereby providing the potential difference between reflective part 110 and common electrode 108. Transmissive part 112 transmits light from light source 102 to illuminate pixel 100. Substrates 114 and 116 enclose liquid crystal material 104, pixel electrode 106 and common electrode 108. In an embodiment, pixel electrode 106 is located at substrate 114, and common electrode 108 is located at substrate 116. Additionally, substrate 114 and pixel electrode layer comprises switching elements (not shown in FIG. 1). In an embodiment, the switching elements can be Thin Film Transistors (TFTs). In another embodiment the switching elements can be low temperature polysilicon.

A pixel driver circuit 130, which may be a part of or in addition to a display driving circuit such as column drivers, sends signals related to pixel values to the switching elements. In an embodiment, pixel driver circuit 130 uses a low voltage differential signaling (LVDS) interface. In another embodiment, a transistor-transistor logic (TTL) interface that senses both increase and decrease in voltages is used in pixel driver circuit 130. Additionally, a timing controller 140 encodes signals related to pixel values into the signals needed by the transmissive parts of the pixels, and signals related to pixel values into the signals needed by the reflective parts of the pixels. Furthermore, timing controller 140 may or may not have a memory to allow self-refresh of the LCD when the signals related to the pixels are removed from timing controller 140.

In an embodiment, spacers 118a and 118b are placed over reflective part 110 to maintain a uniform distance between substrates 114 and 116. Additionally, pixel 100 comprises first polarizer 120 and second polarizer 122. In an embodiment, the axes of polarity of first polarizer 120 and second polarizer 122 are perpendicular to each other. In another embodiment, the axes of polarity of first polarizer 120 and second polarizer 122 are parallel to each other.

Pixel 100 is illuminated by light source 102 or front light 124. The intensity of light passing through pixel 100 is determined by the potential difference between pixel electrode 106, and common electrode 108. In an embodiment, liquid crystal material 104 is in a disoriented state and the light passing through first polarizer 120 is blocked by second polarizer 122 when no potential difference is applied between pixel electrode 106, and common electrode 108. Liquid crystal material 104 is oriented when the potential difference is applied between pixel electrode 106, and common electrode 108. The orientation of liquid crystal material 104 allows the light to pass through second polarizer 122.

In an embodiment, first reflective layer 160 is placed on one side of electrode 106, while second reflective layer 150 may be placed on the opposite side of electrode 106. The second reflective layer 150 may be made of metal, reflecting or bouncing light 126, which as illustrated is incident from the left-hand side of FIG. 1, one or more times until the light 126 transmits through the transmissive part 112 to illuminate pixel 100.

For the purpose of illustrating a clear example, straight lines indicate light path segments of lights 128, 124, 126. Each of the light path segments may comprise additional bending due to diffractions which may occur when lights 128, 124, 126 travel through junctions between media of different refractive indexes. As illustrated, the light 128 represents transmissive light directly emitted from the backlight.

For the purpose of illustrating a clear example, the pixel 100 is illustrated with two spacers 118a and 118b . In some other embodiments, a spacer may be placed between different planes or locations of a pixel structure. In various embodiments, two neighboring spacers may be placed one or more pixels apart, every ten pixels apart, every twenty pixels apart, every 100 pixels apart, or other distances apart.

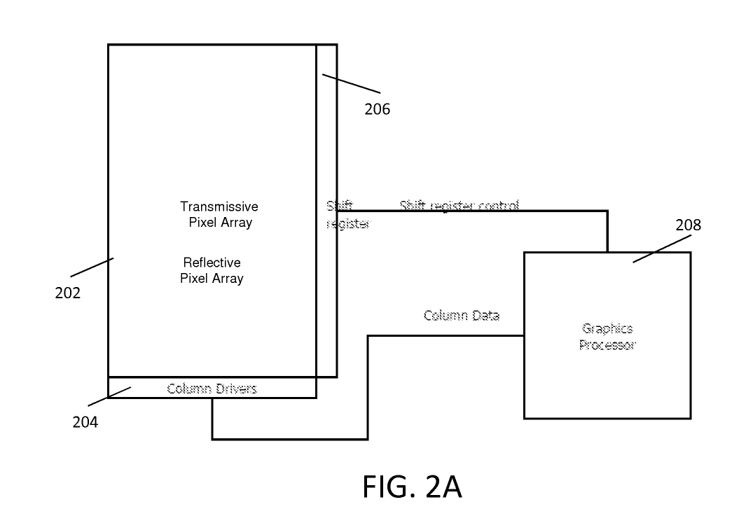

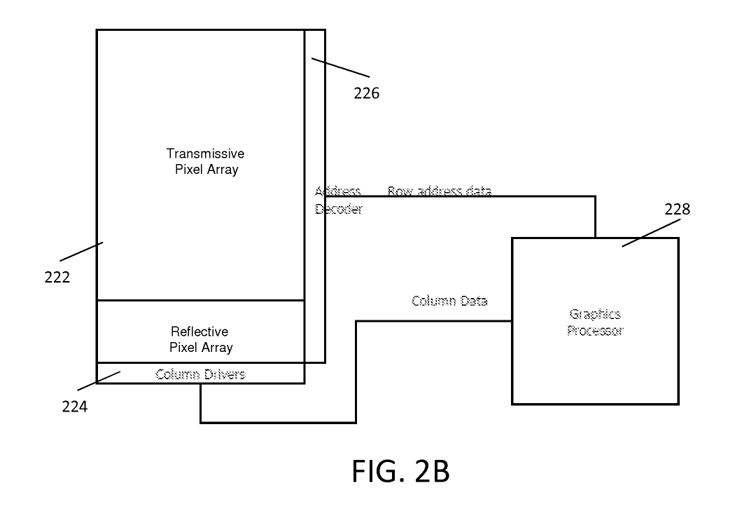

FIG. 2A illustrates an example display panel (202) operatively coupled to an example display driving circuit of a first type. The example display panel (202) may comprise a transmissive pixel array and a reflective pixel array. In some embodiments, the transmissive pixel array may comprise transmissive pixels in the form of transmissive parts (e.g., 112 of FIG. 1) in transflective pixels (e.g., 100 of FIG. 1), whereas the reflective pixel array may comprise reflective pixels in the form of reflective parts (e.g., 110 of FIG. 1) in the transflective pixels (e.g., 100 of FIG. 1). In some embodiments, the display panel (202) may comprise different types of pixels, in addition to or in place of, those illustrated in FIG. 2A.

The example display driving circuit of the first type may comprise a shift register circuit (206) and a column drivers circuit (204). The shift register circuit may comprise a transmissive shift register section and a reflective shift register section configured for the transmissive pixels and reflective pixels, respectively. The column drivers circuit (204) may comprise transmissive column drivers and reflective column drivers configured for the transmissive pixels and reflective pixels, respectively. In some embodiments, a transmissive column driver and a reflective column driver are provided by or implemented with a single column driver. A graphic controller (208), which may be a part of a computing device that renders images or videos on the display panel (202), may be configured to generate column data based on image data for one or more images to be rendered on the display panel (202), and to provide the column data to the column drivers circuit (204). The column data may comprise transmissive column data and reflective column data that are to be used by the transmissive column drivers and the reflective column drivers, respectively. The graphic controller (208) may be further configured to provide shift register control to the shift register circuit (206). The shift register control data may comprise transmissive shift control data and reflective shift control data from the transmissive shift register section and the reflective shift register section, respectively.

Signals from transmissive column drivers, which are generated based on the transmissive column data, may be configured to drive transmissive switching elements of the transmissive pixels in the transmissive pixel array, while signals from reflective column drivers, which are generated based on the reflective column data, may be configured to drive reflective switching elements of the reflective pixels in the reflective pixel array.

The transmissive shift register section may be configured to address individual rows in a plurality of rows in the transmissive pixel array. The transmissive shift register section may initiate a shifting sequence with a corresponding clock signal that moves (e.g., sequentially) enabled portions of the transmissive column data into individual rows in the transmissive pixel array.

The reflective shift register section may be configured to address individual rows in a plurality of rows in the reflective pixel array. The reflective shift register section may initiate a shifting sequence with a corresponding clock signal that moves, for example sequentially, enabled portions of the reflective column data into individual rows in the reflective pixel array.

The display panel (202) may comprise a combination of a plurality of different spatial layouts of the transmissive pixel array and the reflective pixel array. In an example, the display panel (202) may comprise a transflective pixel array formed by interleaving the transmissive pixel array and the reflective pixel array. In another example, at least a portion of the display panel (202) comprises only reflective pixels, or only transmissive pixels, or only transflective pixels.

By changing the spatial layouts of different types of pixels in a display panel, different display and performance characteristics may be concurrently achieved on the display panel by operating concurrently different display modes on different display portions of the display panel. In an example, the display panel (202) may comprise a display portion of transmissive LCD pixel with high transmissive efficiency, good contrast and color saturation; the display portion renders a portion, or a whole, of an overall image using a backlight. In another example, the display panel (202) may comprise a display portion of purely reflective pixels with no color filters (and therefore produces black and white images, possibly with multiple shades of gray); the display portion renders a portion, or a whole, of an overall image using a frontlight. Display portions that combine transmissive pixels/parts and reflective pixels/parts may also be used; these display portions may render images or image portions with either or both of a backlight and a frontlight.

For the purpose of illustration only, a display panel that supports multiple display modes concurrently may comprise transflective pixels having reflective parts and transmissive parts that may be driven with different data values. In other embodiments, the display panel may combine two or more of a wide variety of types of pixels, such as LCD, OLED, etc., in a single display panel. For example, a mobile phone display may combine a display portion of purely transmissive pixels with a different display portion of transflective pixels. Different display portions or sections may be driven and/or illuminated separately to achieve low power operation or other desired distinct features.

A display system as described herein may comprise one or more software and/or hardware components configured to generate, based on image data, different types of driving signals for different types of pixels in a display panel, and to update the different types of pixels in the display panel at same or different rates. Additionally, optionally, or alternatively, driver ICs for the display panel may be configured to drive the different types of pixels with different voltage waveforms. Common electrode voltage may or may not be different for the different types of pixels. Backlight and/or frontlight in the display system may be configured to illuminate the different types of pixels as appropriate.

For a display panel that includes multiple types of pixels, especially if the different types of pixels are to be driven at different refresh rates, a flexible addressing scheme may be used. For example, if one portion of the display panel is composed of transmissive pixels and another portion is composed of reflective pixels, and the overall operating mode is selected to only display information on the reflective pixels, row selection circuitry may be configured to disable rows comprising transmissive pixels.

FIG. 2B illustrates an example display panel (222) operatively coupled to an example display driving circuit of a second type. The example display panel (222) may comprise a transmissive pixel array and a reflective pixel array in a top-down configuration among a plurality of possible spatial configurations. In some embodiments, the transmissive pixel array may comprise transmissive pixels, whereas the reflective pixel array may comprise reflective pixels. In some embodiments, the display panel (222) may comprise different types of pixels, in addition to or in place of, those illustrated in FIG. 2B.

The example display driving circuit of the second type may comprise an address decoder (226) and a column drivers circuit (224). A graphic controller (228), which may be a part of a computing device that renders images or videos on the display panel (222), may be configured to generate column data based on image data for one or more images to be rendered on the display panel (222), and to provide the column data to the column drivers circuit (224). The graphic controller (228) may be further configured to provide row address control to the address decoder (226).

The address decoder (226) may be used as a part of the row selection circuitry to select individual rows for update. Such an address decoder, properly controlled by a graphics processing unit (GPU), may be configured to enable only selective rows of the display panel (222), thereby providing desired screen images while saving power by not driving other rows on the display panel (222). Additionally, optionally, or alternatively, the address decoder (226) may be configured to enable different display portions of the display panel (222) to operate in different display modes, thereby providing desired screen images while saving power by avoiding unnecessarily driving the entire display panel with a high performance display mode. For example, if pixels contain both transmissive and reflective portions, the address decoder (226) may enable only one portion of the pixels in one region of the display, and enable the other portion or neither portion of the pixels in another region of the display. The random access nature of an address decoder makes it superior to making the row selection circuitry from one or more shift registers. An address decoder also allows all rows to be turned off before selecting the next row in a “break before make” drive scheme. This may be useful for preventing image artifacts.

Techniques as described herein may be used to support a scheme of a “non-raster” update of different types of pixels in the display panel. Under this scheme, individual rows in the display panel may or may not be updated in a sequential raster row order; for example, individual rows in the display panel may be updated with a “mixed refresh rate.” Different display portions of the display panel may be updated with different refresh rates, which may include, without limitation, a variable refresh rate, in which selected rows are only updated when the data to be displayed/rendered changes.

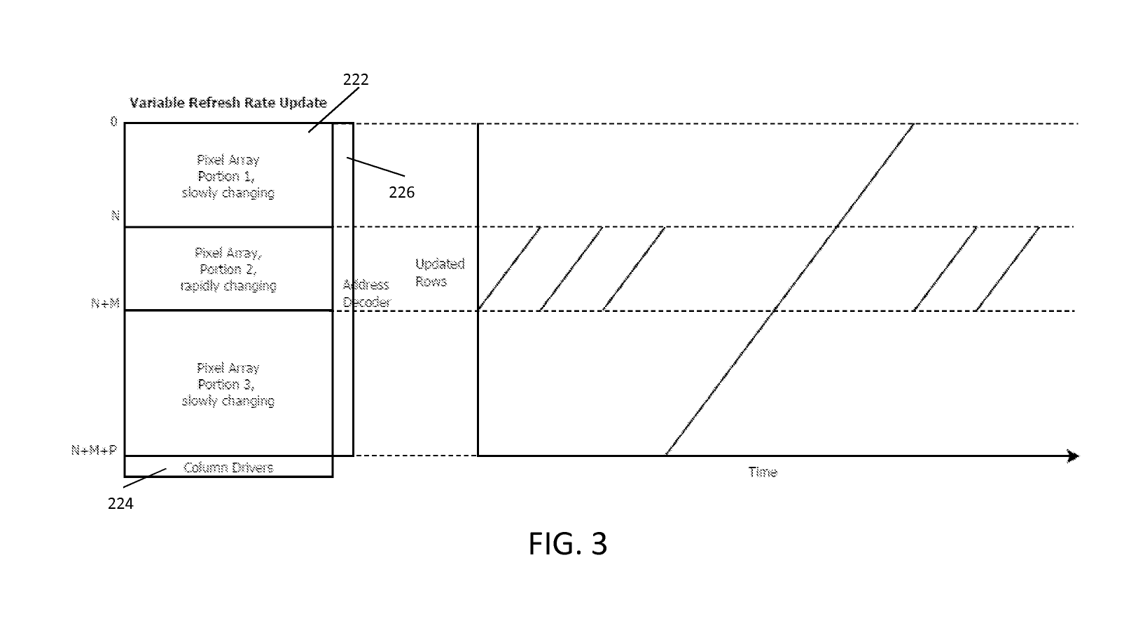

FIG. 3 illustrates an example variable or mixed refresh rate update of a display panel (e.g., 222). As illustrated in an updated rows-time chart of FIG. 3, rows 0 to N in pixel array portion 1 and N+M to N+M+P in pixel array portion 3 may be refreshed once in a time duration depicted in the chart, whereas rows N to N+M in pixel array portion 2 may be refreshed six times, where N, M and P are positive integers. Pixel array portions 1 and 3 may be used to display slowly changing image portions of an overall image frame, whereas pixel array portion 2 may be used to concurrently display fast changing image portions of the image frame.

The use of an address decoder for row selection, rather than the currently common shift register, allows for a variety of driving schemes. For example, different rows of the display may be updated at different refresh rates. This flexibility applies broadly to different display technologies, including LCD, OLED, and MEMS. For example, if some portion of the image is static, such as a page of text, and some portion includes moving images, such as a moving mouse pointer or a blinking cursor, it is possible to update the static rows at, for example, a 30 Hz refresh rate, while the rows containing moving images may be updated at, for example, 60 Hz. In embodiments in which a pixel includes a memory element, only memory elements of pixels that are to be loaded with changing content may be updated.

In some embodiments, a display panel such as a segmented LCD may be configured with a common electrode (Vcom) to be segmented into multiple components that may be driven to different voltages. Such a configuration may be used if undriven rows in the display panel are to remain undriven for a long period of time. For example, a Vcom segment in an undriven region of the display panel may be held at a 0 V (ground) potential to avoid creating a static DC field across the LC material in that region. In contrast, a Vcom segment in a driven region of the display panel may be driven to an appropriate, for example non-zero, voltage for a specific liquid crystal mode. Power supply distribution networks in the display panel or the display system may also be similarly segmented to both enable maximum power savings and to prevent damage to optically active materials such as liquid crystal material that may occur with long-term DC field application. Additionally, optionally, or alternatively, unused pixels in the display panel may be driven to produce black at a very low refresh rate, such as 1 Hz, 2 Hz, etc. Pixels provided using technologies such as OLED or MEMS may not have the same issues that may be related to liquid crystal materials; hence, these pixels may not need to be held with a 0 V DC field or to be driven with a black level voltage at a low refresh rate, as discussed above. Note that the common electrode may be opposite the pixel electrode, as in TN or ECB designs (as shown in FIG. 1), or may be on the same substrate as the pixel electrode, as in IPS or FFS designs. Electrically separating the Vcom segments is simpler if the multiple common electrodes are on the same substrate as the pixel electrode, since patterning and aligning the Vcom conductor on the substrate opposite the pixel electrode may be relatively difficult.

Pixel brightness levels may change when different display portions of a display panel are refreshed at different frequencies, resulting in possible flickering artifacts. For example, updating or refreshing many discrete, non-contiguous rows of a display panel at a high refresh rate (e.g., 60 Hz) while updating or refreshing the remainder of the display panel at a lower rate (e.g., 30 Hz), may result in a visual artifact of undesirable flickers. In some embodiments, a display system as described herein may be configured to avoid visual artifacts when a non-raster update is performed. For example, updating or refreshing a display portion that comprises contiguous rows may avoid the above discussed undesirable artifacts.

In some embodiments, selecting a row of pixels connects the pixel storage node for each pixel to an associated column wire. A valid pixel voltage may be present on the column wire. All the pixels in the row may be updated at once. In some other embodiments, a subset of pixels in a row may be selected and updated. Additional selection circuitry and/or control logic including but not limited to any of additional switching elements (such as transistors) in each pixel may be used to enable selecting the pixels for update.

A display panel that comprises multiple display portions/segments each capable of supporting one or more display modes may be configured to support a number of enumerated display states.

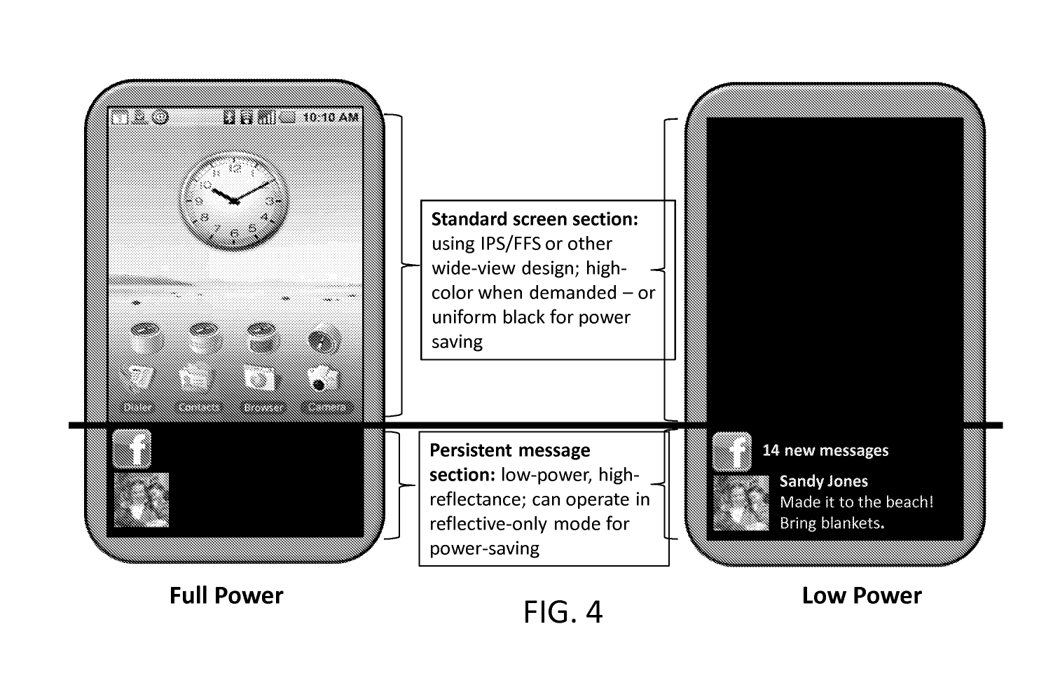

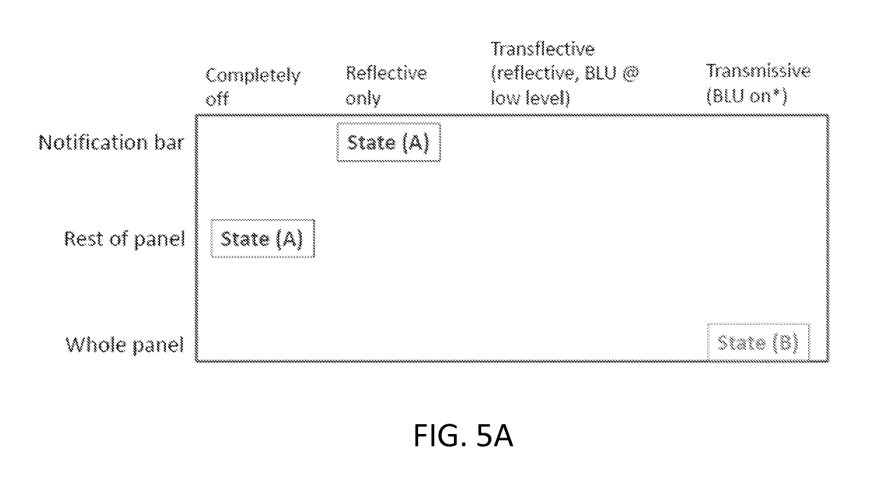

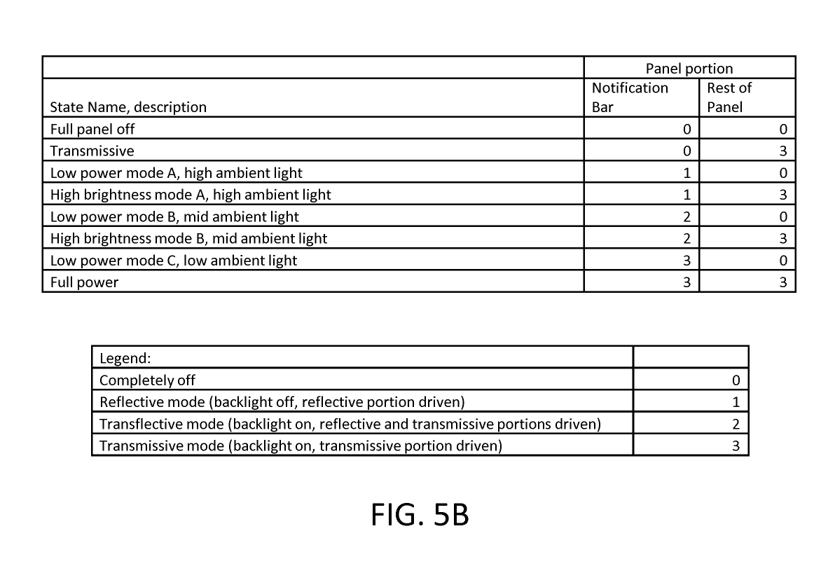

FIG. 4 illustrates two example display states for a computing device or display system. The display panel in the two states as illustrated in FIG. 4 may comprise a standard screen section and a persistent notification section. The standard screen section may be implemented using a wide-view design such as in-plane-switching (IPS), fringe-field-switching (FFS), or other techniques. The standard screen section may operate in a full power display mode of high color when demanded, or a display mode of uniform black for power saving. The persistent notification section may be implemented using a low-power, high reflectance design, and may operate in a reflective-only display mode for power saving, a transmissive display mode in no or low front light viewing conditions, or a transflective display mode when both backlight and front light including but not limited to ambient light are available.

A display system operating with the display panel may be configured to use a variety of techniques to select a display state (or an operating mode) in which one, two, or more possibly different display modes may be concurrently used to update different portions of a display panel. For example, the display system may be configured to select a particular display state based on one or more of types of running computing applications, types of computing devices, spatial configurations of different types of pixels, user input, user activities, battery charge levels, selected display applications, ambient light conditions, etc. For example, the display system may be configured to receive user input including but not limited to key pressing, button pushing, etc. A display system may receive user input that requests selecting a “standby” display state in which a transmissive display portion or part of a display panel may be shut off, while a transflective display portion or part is placed into a low power reflective mode.

It should be noted that some types of pixels may allow a display segment to support more display modes than some other types of pixels. For example, a transflective pixel may support driving different pixel data to reflective and transmissive portions, respectively, of the pixel. A display portion/segment of a display panel may be driven so as to make all the reflective portions black, thereby placing the display portion/segment into a purely transmissive mode. Alternatively, the backlight illumination may be spatially controlled; the backlight for a portion of the display panel may be dimmed or turned off, thereby placing the display portion/segment into a purely reflective mode.

FIG. 5A illustrates example mappings between display states for a computing device or display system and display modes of different display portions of a display panel. The display states may include, without limitation, State (A) and State (B) as illustrated in FIG. 5A. The whole display panel may include, without limitation, a notification bar and the rest of display panel. In State (A), the notification bar and the rest of the display panel may be configured to operate concurrently in a reflective only display mode and in a completely off display mode, respectively. In State (B), the whole display panel may be configured to operate in transmissive display modes. A display state such as State (B), which is a transmissive state, may be implemented in one or more of a variety of techniques. For example, the display system, or the display panel thereof, may be configured to selectively turn off one or more reflective portions of a pixel or subpixel.

FIG. 5B also illustrates example mappings between display states for a computing device or display system and display modes of different display portions of a display panel. The display states may include, without limitation, multiple low power states for different ambient conditions, or multiple high power modes for different image quality, as illustrated in FIG. 5B. The whole display panel may include, without limitation, a notification bar and the rest of display panel. In low power mode (A), the notification bar and the rest of the display panel may be configured to operate concurrently in a reflective only display mode and in a completely off display mode, respectively. In full power mode, the whole display panel may be configured to operate in transmissive display modes. A display state such as full power mode, which is a transmissive state, may be implemented in one or more of a variety of techniques. For example, the display system, or the display panel thereof, may be configured to selectively turn off one or more reflective portions of a pixel or subpixel. FIG. 5B shows possible states for a display in which the notification bar supports four different operating modes and the rest of the panel supports two different operating modes, but each portion could support more or fewer modes than shown.

### 3. EXAMPLE COMPUTING DEVICE

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, analog circuits, mixed signal devices, handsets, networking devices or any other device that incorporates hard-wired and/or program logic to implement the techniques.

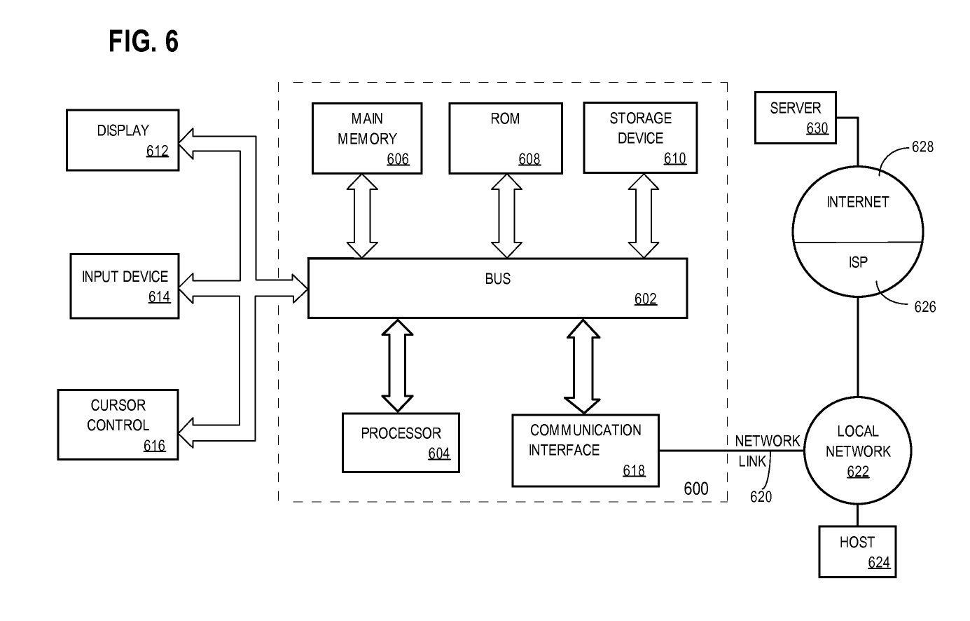

For example, FIG. 6 is a block diagram that illustrates a computer system 600 upon which a possible embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor, digital signal processor, or other processor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a liquid crystal display apparatus, for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618. The received code may be executed by processor 604 as it is received, and/or stored in storage device 610, or other non-volatile storage for later execution.

### 4. EXTENSIONS AND VARIATIONS

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

This disclosure assumes familiarity with U.S. nonprovisional patent application Ser. No. 12/503,793, filed Jul. 15, 2009; application Ser. No. 12/510,498, filed Jul. 28, 2009; application Ser. No. 12/510,485, filed Jul. 28, 2009; application Ser. No. 12/510,424, filed Jul. 28, 2009; application Ser. No. 12/560,258, filed Sep. 15, 2009; application Ser. No. 12/560,217, filed Sep. 15, 2009; application Ser. No. 12/628,974, filed Dec. 1, 2009; application Ser. No. 12/630,800, filed Dec. 3, 2009; application Ser. No. 12/712,439, filed Feb. 25, 2010; application Ser. No. 12/782,574, filed May 18, 2010; application Ser. No. 12/948,174, filed Nov. 17, 2010; application Ser. No. 13/044,064, filed Mar. 9, 2011; application Ser. No. 13/155,151, filed Jun. 7, 2011; application Ser. No. 13/208,528, filed Aug. 12, 2011; the entire contents of which are hereby incorporated by reference for all purposes as if fully set forth herein.

What is claimed is:

1. A display panel that comprises two or more display portions having two or more different types of pixels in two or more different spatial segments of the display panel.

2. The display panel of claims 1, wherein image content on at least two of the two or more different display portions in the display panel is configured to be refreshed at two different refreshing rates.

3. The display panel of claims 1, wherein the display panel represents a single monolithic display module.

4. A display panel that is coupled to a display driving circuit configured to drive two or more display portions in two or more different spatial segments of the display panel to operate in two or more different display modes.

5. The display panel of claims 4, wherein image content on at least two of the two or more different display portions in the display panel is configured to be refreshed at two different refreshing rates.

6. The display panel of claims 4, wherein the display panel represents a single monolithic display module.

7. A computing device that comprises one or more computing processors and a display panel, as recited in claim 1, which is coupled to the one or more computing processors.

8. A computing device that comprises one or more computing processors and a display panel, as recited in claim 2, which is coupled to the one or more computing processors.

9. A computing device that comprises one or more computing processors and a display panel, as recited in claim 3, which is coupled to the one or more computing processors.

10. A computing device that comprises one or more computing processors and a display panel, as recited in claim 4, which is coupled to the one or more computing processors.

11. A computing device that comprises one or more computing processors and a display panel, as recited in claim 5, which is coupled to the one or more computing processors.

12. A computing device that comprises one or more computing processors and a display panel, as recited in claim 6, which is coupled to the one or more computing processors.

13. A method for fabricating a display panel as recited in claim 1.

14. A method for fabricating a display panel as recited in claim 2.

15. A method for fabricating a display panel as recited in claim 3.

16. A method for fabricating a display panel as recited in claim 4.

17. A method for fabricating a display panel as recited in claim 5.

18. A method for fabricating a display panel as recited in claim 6.

19. A method for rendering images using a display panel as recited in claim 1.

20. A method for rendering images using a display panel as recited in claim 4.
